(19) United States
(12) Patent Application Publication
(10) Pub. No.: US 2022/0050537 A1
(43) Pub. Date: Feb. 17, 2022

(54) ELECTRONIC DEVICE

(71) Applicant: ASUSTEK COMPUTER INC., Taipei (TW)

(72) Inventors: Jau-Yi WU, TAIPEI (TW); Sheng-Ta LIN, TAIPEI (TW)

(21) Appl. No.: 17/399,732

(22) Filed: Aug. 11, 2021

(30) Foreign Application Priority Data
Aug. 14, 2020 (TW) 109127771

(51) Int. Cl. G06F 3/0354; G06F 1/16

(52) U.S. Cl. CPC G06F 3/03547; G06F 1/1616; G06F 1/169

(57) ABSTRACT

An electronic device is provided. The electronic device includes a body and a touch pad. The body includes a surface. The touch pad is disposed on the surface. The touch pad includes a flat region and a first declined region. The first declined region extends from the flat region to an edge of the surface, and the first declined region is inclined downward from the flat region with a first inclination angle.

### CROSS-REFERENCE TO RELATED APPLICATION

This application claims the priority benefit of Taiwan application serial No. 109127771, filed on Aug. 14, 2020. The entirety of the above-mentioned patent application is hereby incorporated by reference herein and made a part of the specification.

### BACKGROUND OF THE INVENTION

### Field of the Invention

The disclosure relates to an electronic device and, more particularly, to an electronic device with a touch pad.

### Description of the Related Art

Conventionally, a touch function is executed only in a touch region of a notebook computer, and the touch region is limited in a range of a touch pad. The location of the touch pad is limited by the structure configuration of a notebook casing, a keyboard and internal electronic components. Thus, the touch operation provided by the traditional notebook computer is relatively limited.

### BRIEF SUMMARY OF THE INVENTION

An electronic device is provided. The electronic device includes a body including a surface; and a touch pad disposed on the surface, the touch pad includes a flat region and a first declined region, the first declined region extends from the flat region to an edge of the surface, and the first declined region is inclined downward from the flat region with a first inclination angle.

In the disclosure, the range of the touch region extends to the outside of the touch pad of the electronic device to meet touch operation requirements and enhance operating experience.

### BRIEF DESCRIPTION OF THE DRAWINGS

FIG. 1 is a schematic diagram of an electronic device according to an embodiment of disclosure.

FIG. 2A is a side view of the touch pad in FIG. 1.

FIG. 2B is a top view of the touch pad in FIG. 1.

FIG. 3 is a schematic diagram of an electronic device according to an embodiment of disclosure.

FIG. 4A is a front view of the touch pad in FIG. 3.

FIG. 4B is a top view of the touch pad in FIG. 3.

FIG. 5 is a schematic diagram of an electronic device according to an embodiment of disclosure.

FIG. 6A is a side view of the touch pad in FIG. 5.

FIG. 6B is a front view of the touch pad in FIG. 5.

FIG. 6C is a top view of the touch pad in FIG. 5.

### DETAILED DESCRIPTION OF THE EMBODIMENTS

These and other features, aspects and advantages of the present disclosure will become better understood with regard to the following description, appended claims, and accompanying drawings. The components shown in figures are not used for limit the size or the proportion.

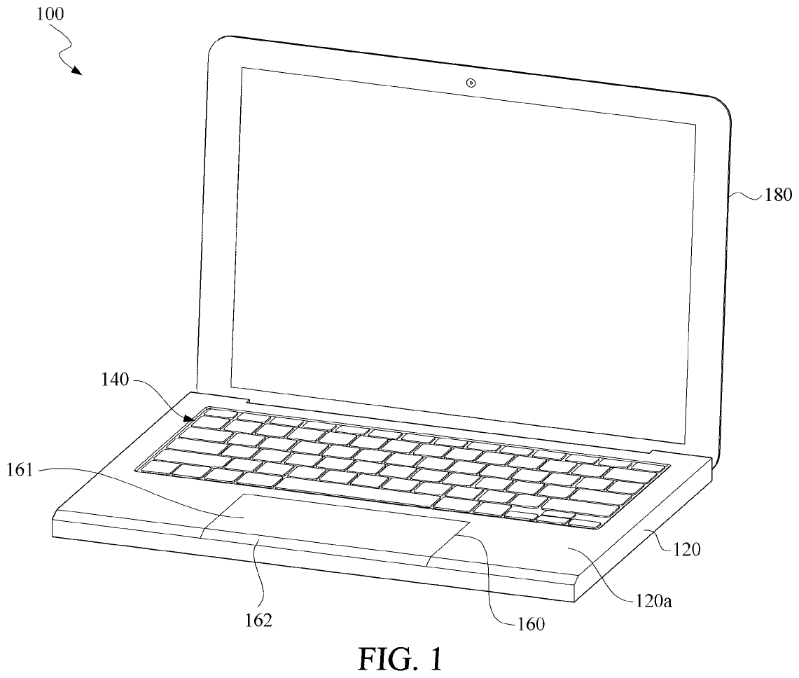

FIG. 1 is a schematic diagram of an electronic device according to an embodiment of disclosure. In the embodiment, the electronic device is a notebook. As shown in FIG. 1, an electronic device 100 includes a body 120, a keyboard 140, a touch pad 160, and a screen 180.

The body 120 includes a surface 120a. The touch pad 160 and the keyboard 140 are disposed on the surface 120a. The screen 180 is pivotally connected with the body 120. In an embodiment, the screen 180 is pivotally connected with a side of the body 120 away from the touch pad 160. The keyboard 140 is disposed between the touch pad 160 and the screen 180, which is not limited herein.

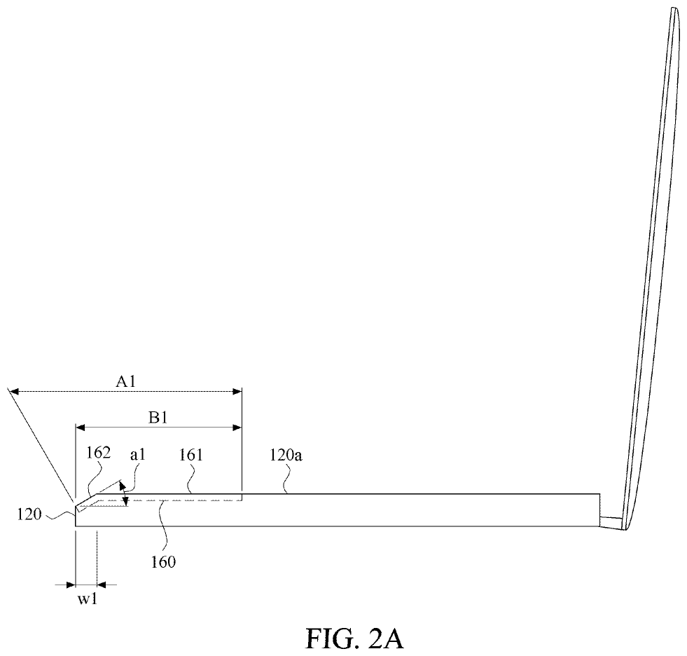

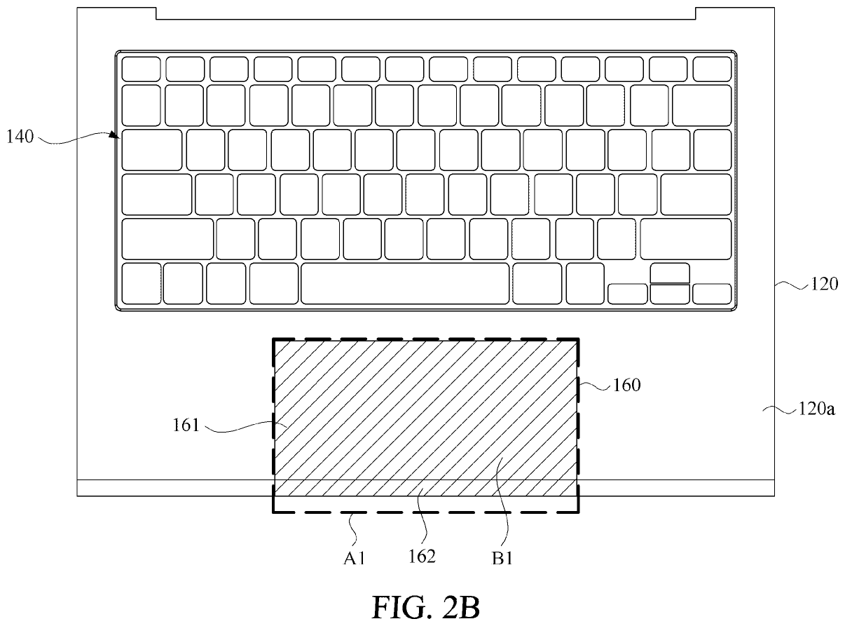

The touch pad 160 includes a flat region 161 and a first declined region 162. Please also refer to FIG. 2A. FIG. 2A is a side view of the touch pad in FIG. 1. The first declined region 162 extends from the flat region 161 to an edge of the surface 120a of the body 120. The flat region 161 is inclined downwardly with a first inclination angle a1. In comparison with other regions of the touch pad 160, a normal direction of the first declined region 162 is slightly outward.

Please refer to FIG. 2B. FIG. 2B is a top view of the touch pad 160 in FIG. 1. The touch region A1 of the electronic device 100 extends to an outer side of the surface 120a of the body 120 due to the first declined region 162. The touch region A1 extends to the outside of the vertical projection range B1 of the touchpad 160 on the surface 120a. The vertical projection range B1 is the coverage range of the touch pad 160 on the surface 120a.

In an embodiment, the first declined region 162 is located at a side of the surface 120a of the body 120 away from the screen 180, which is a side of the surface 120a of the body 120 close to the user when the user operates with the electronic device 100.

In an embodiment, the width w1 of the first declined region 162 is between 5% and 10% of a length of the short side of the vertical projection range B1. The first inclination angle a1 is between 0 and 90 degrees.

In an embodiment, the range of the touch region A1 is increased from the vertical projection range B1 of the touch pad 160 on the surface 120a outward by 5% to 10% via the first declined region 162.

In an embodiment, a preset distance exists between the touch pad 160 and the keyboard 140 to avoid misoperations, which is not limited herein. In an embodiment, the touch pad 160 extends to the keyboard 140 to enlarge the touch region A1.

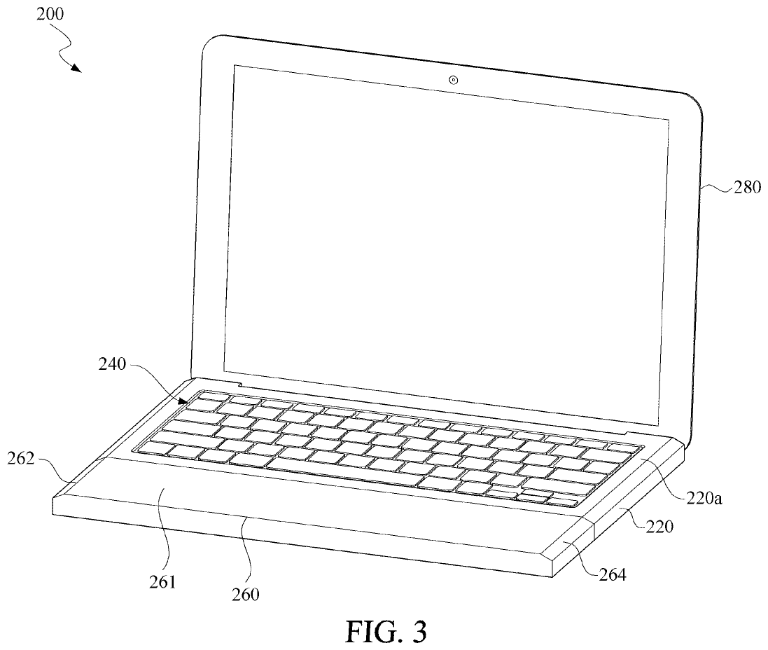

FIG. 3 is a schematic diagram of an electronic device according to an embodiment of disclosure. In the embodiment, an electronic device is a notebook computer. As shown in FIG. 3, the electronic device 200 includes a body 220, a keyboard 240, a touch pad 260, and a screen 280.

The main difference between the electronic device 200 in this embodiment and the electronic device 100 of the above embodiment is that the touch pad 260 of this embodiment includes a flat region 261, a first declined region 262, and a second declined region 262 region 264, and the second declined region 264 is located at a side opposite to the first declined region 262.

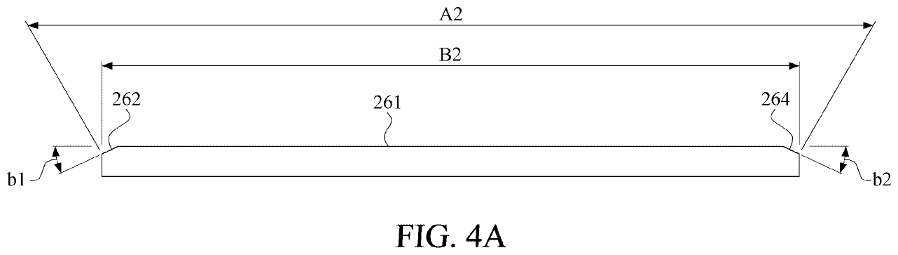

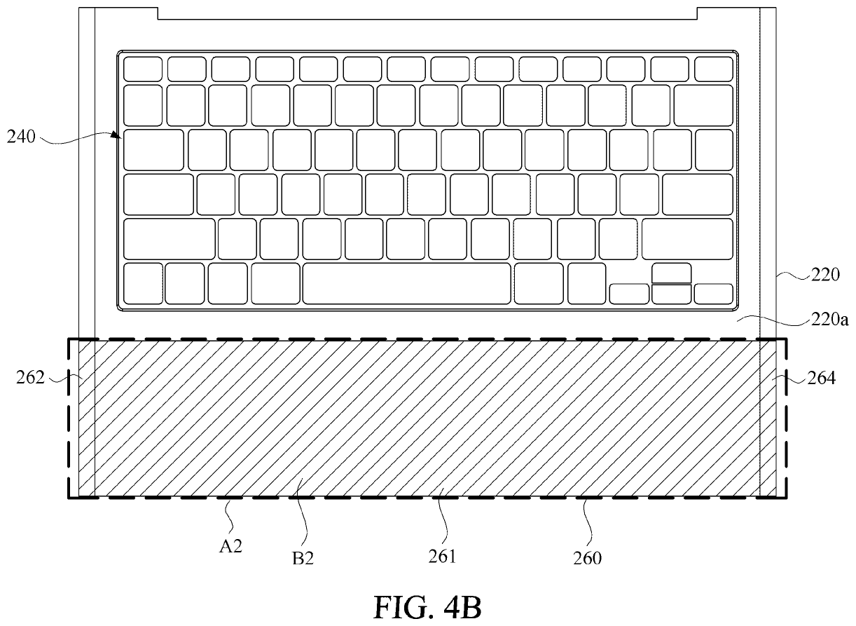

Both the first declined region 262 and the second declined region 264 extend from the flat region 261 to the edges of the surface 220a of the body 220, respectively. Please also refer to FIG. 4A. FIG. 4A is a front view of the touch pad 260 in FIG. 3. The first declined region 262 is inclined downward from the flat region 261 with the first inclination angle b1. The second declined region 264 is inclined downward from the flat region 261 with the second inclination angle b2.

In the embodiment, the first declined region 262 and the second declined region 264 are located at the left and the right sides of the surface 220a of the body 220 relative to the screen 280, respectively. The first declined region 262 is inclined toward the lower left of the body 220 with the first inclination angle b1.

The second declined region 264 is inclined toward the lower right of the body 220 with the second inclination angle b2. Please also refer to FIG. 4B. FIG. 4B is a top view of the touch pad 260 in FIG. 3. The touchable region of the touch region A2 of the electronic device 200 extends horizontally beyond the touch pad 260 due to the first declined region 262 and the second declined region 264.

The inclination angles of the first declined region 262 and the second declined region 264 affect the extending range of the touch region A2. In an embodiment, the first inclination angle b1 of the first declined region 262 is equal to the second inclination angle b2 of the second declined region 264 to provide a left-right symmetrical touch region A2 for a better operating experience.

In an embodiment, the range of the touch region A2 is increased from the vertical projection range B2 of the touch pad 260 on the surface 220a outward by 5% to 10% via the first declined region 262 and the second declined region 264.

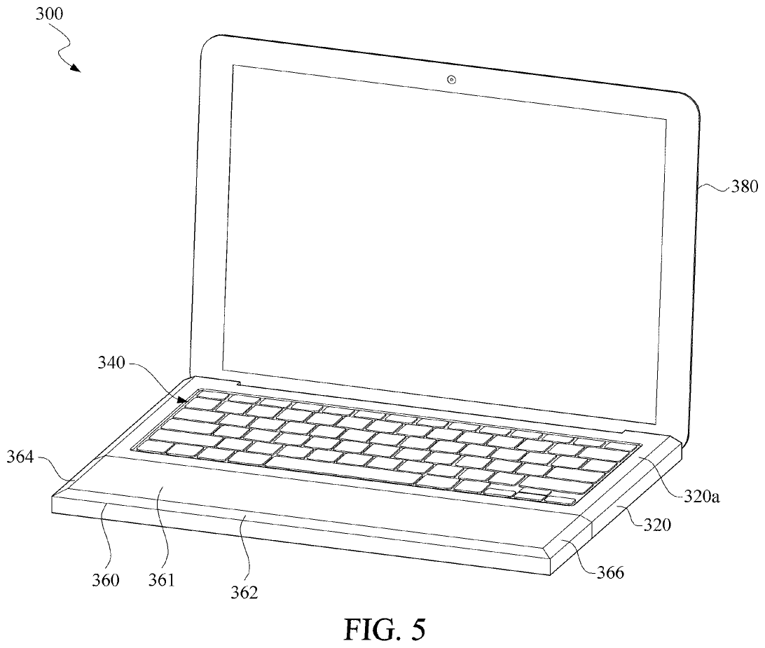

FIG. 5 is a schematic diagram of an electronic device according to an embodiment of disclosure. In the embodiment, the electronic device is a notebook computer 300, which is not limited herein. The electronic device 300 includes a body 320, a keyboard 340, a touch pad 360, and a screen 380.

The main difference between the electronic device 300 in this embodiment and the electronic device 100 in the above embodiment is that the touch pad 360 in this embodiment includes a flat region 361, a first declined region 362, a second declined region 364, and a third declined region 366. The second declined region 364 is located at an adjacent side of the first declined region 362, and the third declined region 366 is located at the opposite side of the second declined region 364.

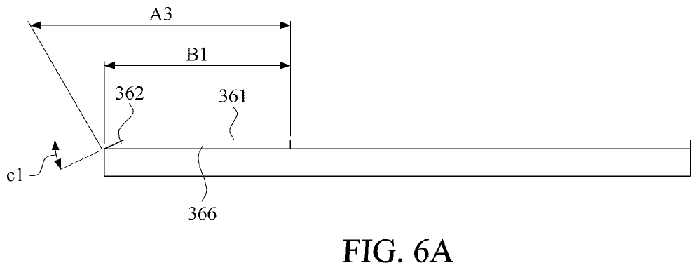

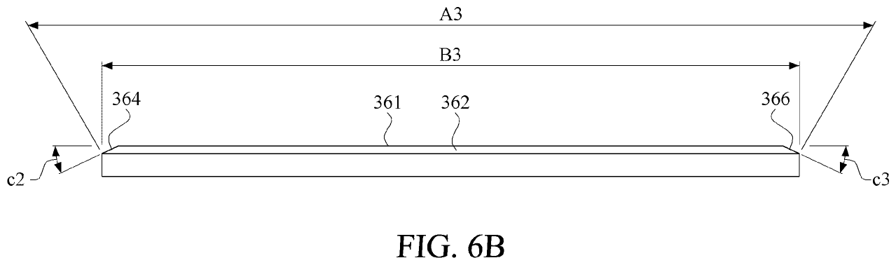

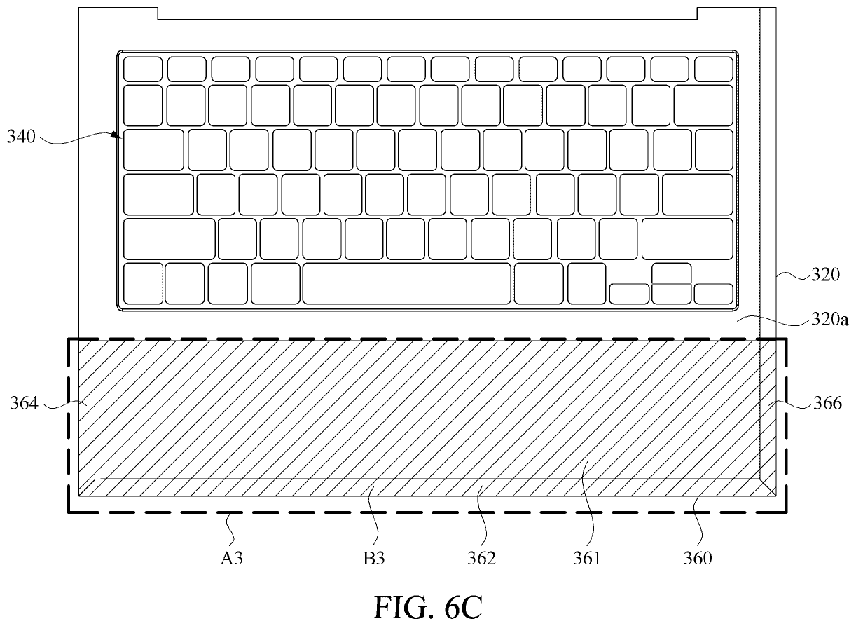

Please refer to FIG. 6A and FIG. 6B. FIG. 6A is a side view of the touch pad 360 in FIG. 5. FIG. 6B is a front view of the touch pad 360 in FIG. 5. The first declined region 362 extends from the flat region 361 to the edge of the surface 320a of the body 320, and the first declined region 362 is inclined downward from the flat region 361 with the first inclination angle c1.

The second declined region 364 extends from the flat region 361 to the edge of the surface 320a of the body 320, and the second declined region 364 is inclined downward from the flat region 361 with the second inclination angle c2. The third declined region 366 extends from the flat region 361 to the edge of the surface 320a of the body 320, and the third declined region 366 is inclined downward from the flat region 361 with the third inclination angle c3.

In this embodiment, the first declined region 362 is located at the side of the surface 320a of the body 320 away from the screen 380, that is, the surface 320a of the body 320 is close to the user when the user operates. The second declined region 364 and the third declined region 366 are located at the left and right sides of the surface 320a of the body 320 relative to the screen 380, respectively.

The first declined region 362 is inclined downward from the flat region 361 with the first inclination angle c1 toward the user, the second declined region 364 is inclined downward from the flat region 361 with the second inclination angle c2 toward the lower left of the body 320, and the third declined region 366 is inclined toward the lower right of the body 320 with the third inclination angle c3.

FIG. 6C is a top view of the touch pad 360 in FIG. 5. FIG. 6C is a top view of the touch pad 360 in FIG. 5. The touch region A3 of the electronic device 300 extends beyond the touch pad 360 via the first declined region 362, the second declined region 364, and the third declined region 366.

The inclination angles of the first declined region 362, the second declined region 364 and the third declined region 366 affect the extending range of the touch region A3. Touch operations of the left and right directions are usually more convenient than those of the front and rear directions for users.

In an embodiment, the second inclination angle c2 corresponding to the second declined region 364 and the third inclination angle c3 corresponding to the third declined region 366 are larger than the first inclination angle c1 corresponding to the first declined region 362 to enlarge the left and right range of the touch region A3.

In an embodiment, the range of the touch region A3 is increased from the vertical projection range B3 of the touch pad 360 on the surface 320a outward by 5% to 10% via the first declined region 362, the second declined region 364, and the third declined region 366.

The electronic device is a notebook computer in the embodiment, which is not limited herein. In another embodiment, the electronic device is a tablet computer or an external touch pad with a touch function, which is not limited herein.

In the above embodiments, the touch pads 160, 260 and 360 and the keyboards 140, 240 and 340 are disposed at the same the surface 120a, 220a, 320a of the body 120, 220, 320, respectively, which is not limited herein.

In an embodiment, the touch pad and the keyboard are disposed at different surfaces of the body to provide different operation experiences. For example, the keyboard is disposed on an upper surface of the body, and the touch pad is disposed at the left side, the right side, or the front side of the body.

In embodiments, the range of the touch region extends to the outside of the touch pad of the electronic device to meet touch operation requirements and enhance operating experience.

Although the present disclosure has been described in considerable detail with reference to certain preferred embodiments thereof, the disclosure is not for limiting the scope of the disclosure. Persons having ordinary skill in the art may make various modifications and changes without departing from the scope. Therefore, the scope of the appended claims should not be limited to the description of the preferred embodiments described above.

What is claimed is:

1. An electronic device, comprising:
a body, including a surface; and
a touch pad, disposed on the surface, wherein the touch pad includes a flat region and a first declined region, the first declined region extends from the flat region to an edge of the surface, and the first declined region is inclined downward from the flat region with a first inclination angle.

2. The electronic device according to claim 1, wherein the touch pad further includes a second declined region, the second declined region is located at a side opposite to the first declined region, the second declined region extends to another edge of the surface from the flat region, and the second declined region is inclined downward from the flat region with a second inclination angle.

3. The electronic device according to claim 2, wherein the first inclination angle is equal to the second inclination angle.

4. The electronic device according to claim 1, wherein the touch pad further includes a second declined region, the second declined region is adjacent to the first declined region, the second declined region extends to another edge of the surface from the flat region, and the second declined region is inclined downward from the flat region with a second inclination angle.

5. The electronic device according to claim 4, wherein the second inclination angle is larger than the first inclination angle.

6. The electronic device according to claim 1, further comprising a keyboard disposed on the surface.

7. The electronic device according to claim 1, wherein a width of the first declined region is between 5% and 10% of a length of a short side of a vertical projection range of the touch pad on the surface.

8. The electronic device according to claim 1, wherein the first inclination angle is between 0 to 90 degrees.

9. The electronic device according to claim 1, further comprising a screen pivotally connected with a side of the body away from the touch pad.
